(19) United States
(12) Patent Application Publication
(10) Pub. No.: US 2009/0248801 A1
(43) Pub. Date: Oct. 1, 2009

(54) Automatic Change Detection and Notification System and Method

(75) Inventors: Oliyer Then, Aidlingen (DE); Gerald Muecke, Stuttgart (DE)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/059,638

(22) Filed: Mar. 31, 2008

(51) Int. Cl. G06F 15/16

(52) U.S. Cl. 709/204

(57) ABSTRACT

A method for automatic change detection and notification comprising the steps of storing at least one subscription corresponding to a notification preference of at least one user; detecting at least one change made to a collaborative editor; determining the change level class of the at least one change; comparing the change level class with the notification preference of the at least one user; and transmitting a notification to the at least one user if the change level class corresponds to the notification preference of the at least one user.

### BACKGROUND OF THE INVENTION

1. Field of the Invention

The present invention relates to a method wherein changes made to collaborative editors and text processors are detected and a notification is sent to subscribers.

2. Description of Background

Collaborative editors and text processors (such as Internet websites and applications including wikis and blogs) allow users to make textual contributions to their content. The authors as well as other users may edit existing contributions. Once edits are made to the website or application, the original author may be notified of the edits. In addition, other users of the collaborative editors and text processors may also subscribe to be informed when an edit is made. However, the author and/or subscribers may only want to be notified regarding specific types of changes that are made to the collaborative editor and text processor content. For instance, an author or subscriber may not be interested in being notified of grammatical, spelling or punctuation corrections, or the inserting or deleting of single missing or duplicative words. Such cases may be considered as only minor edits. In order to identify the nature of the edits that are being made, some websites and applications allow the editing user to indicate the nature of the edits. For example, the editing user may manually select a checkbox indicating whether the change is a major change or a minor change.

A drawback with a system that allows the editing user to manually indicate the nature of the edit is the human error factor. For example, in the example above, the editing user may forget to select the minor change option. This will result in the author and subscribers being notified of edits that do not contain information of interest to them. In addition, when the editing user is left with the choice to determine whether a change is major or minor, the conclusions may oftentimes differ from the subscriber's and the subscriber may receive too many or not enough notifications when changes are made.

### SUMMARY OF THE INVENTION

A method for automatic change detection and notification comprising the steps of storing at least one subscription corresponding to a notification preference of at least one user; detecting at least one change made to a collaborative editor; determining the change level class of the at least one change; comparing the change level class with the notification preference of the at least one user; and transmitting a notification to the at least one user if the change level class corresponds to the notification preference of the at least one user.

It is an object of the present invention to increase the value of change notifications, thereby reducing unnecessarily generated information.

It is a further object of the present invention to increase the usability of collaborative editors and text processors.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A illustrates an exemplary environment for managing the processes in accordance with the invention.

FIG. 1B illustrates an exemplary schematic diagram in accordance with one exemplary embodiment of the present invention

FIG. 2A illustrates an exemplary procedural flow chart in accordance with one exemplary embodiment of the present invention.

FIG. 2B illustrates another exemplary procedural flow chart in accordance with one exemplary embodiment of the present invention.

The detailed description explains the preferred embodiments of the invention, together with advantages and features, by way of example with reference to the drawings.

### DETAILED DESCRIPTION OF THE INVENTION

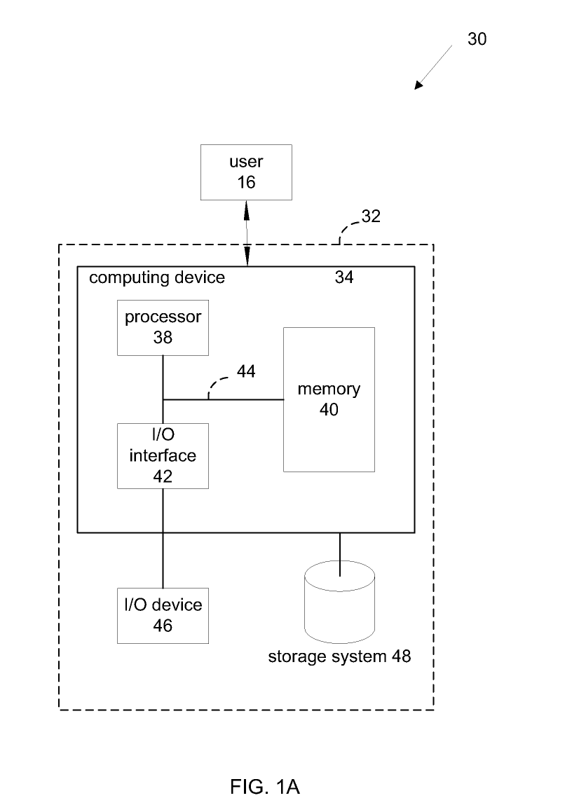

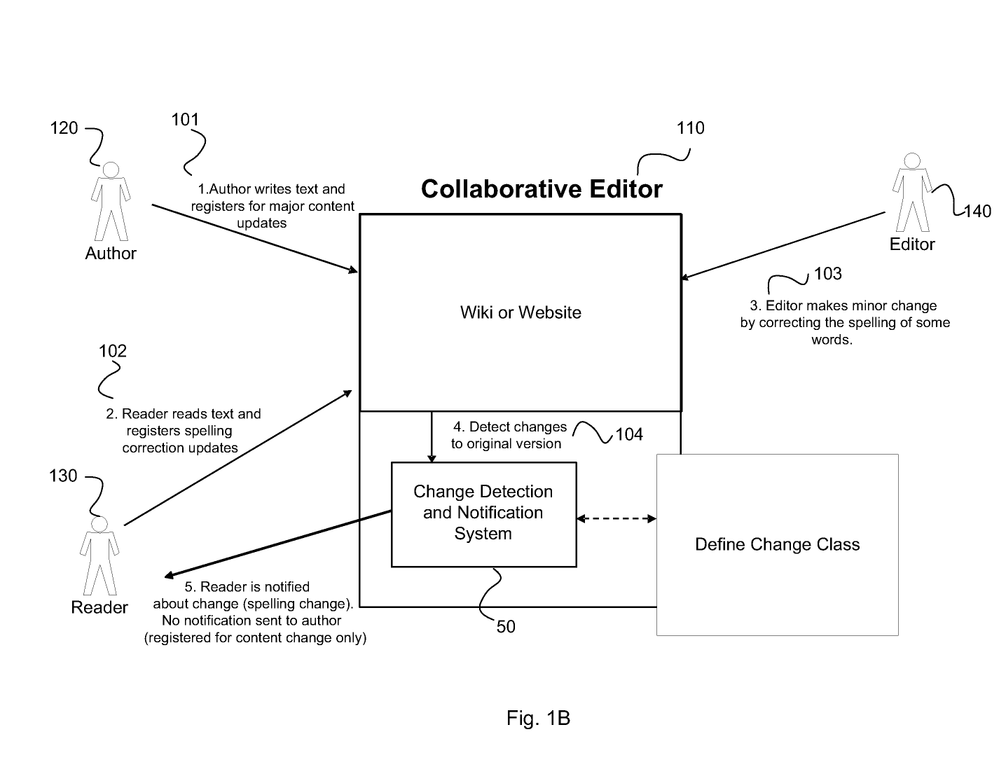

With reference to the accompanying drawings, FIG. 1A shows an illustrative environment 30 for computer user 16 to manage the processes in accordance with the invention. To this extent, the environment 30 includes a computer infrastructure 32 that can perform the processes described herein. In particular, the computer infrastructure 32 is shown including a computing device 34 operable to perform the processes described herein. The computing device 34 is shown including a processor 38, a memory 40, an input/output (I/O) interface 42, and a bus 44. Further, the computing device 34 is shown in communication with an external I/O device/resource 46 and a storage system 48. As is known in the art, in general, the processor 38 executes computer program code, which is stored in memory 40 and/or storage system 48. While executing computer program code, the processor 38 can read and/or write data, such as the range boundary 50, to/from memory 40, storage system 48, and/or I/O interface 42. The bus 44 provides a communications link between each of the components in the computing device 34. The I/O device 46 can comprise any device that enables an individual to interact with the computing device 34 or any device that enables the computing device 34 to communicate with one or more other computing devices using any type of communications link.

The computing device 34 can comprise any general purpose computing article of manufacture capable of executing computer program code installed thereon (e.g., a personal computer, server, handheld device, etc.). However, it is understood that the computing device 34 is only representative of various possible equivalent computing devices that may perform the processes described herein. Similarly, the computer infrastructure 32 is only illustrative of various types of computer infrastructures for implementing the invention. For example, in one embodiment, the computer infrastructure 32 comprises two or more computing devices (e.g., a server cluster) that communicate over any type of communications link, such as a network, a shared memory, or the like, to perform the process described herein.

FIG. 1B illustrates an exemplary schematic diagram of edits made to a collaborative editor 110. In step 101, author 120 writes original text and registers with the collaborative editor 110 for notifications indicating any major content updates made to the text. In step 102, reader 130 reads author's text and registers with the collaborative editor for notifications indicating any spelling correction updates. In step 103, editor 140 makes updates to the text by correcting the spelling of some words. In step 104, change detection and notification system 50 defines the nature of the change without editor 140 having to indicate the nature of the change as will be discussed in further detail below. The change detection and notification system 50 determines that the changes made by editor 140 were only spelling corrections and notifies reader 130, who has registered for notifications relating to spelling correction updates. Author 120 is not notified of this change because author 120 has only registered for notifications relating to major content updates, and change detection and notification system 50 has determined that the changes made by editor 140, in this exemplary instance, are spelling changes and not major content updates.

Change detection and notification system 50 may define a set of change classes. To define a change class, attributes are used that match textual elements (such as punctuation, character, numeral, word, subordinate, sentence, paragraph, chapter, heading, enumeration, table, cite, and format), the type of change (such as add, delete, and change), and the minimum, maximum or exact amount of occurrence. Occurrences can be consecutive. Change classes may be defined by the following exemplary code:

Syntax
[level] {
attribute: value;
}
<attribute> = ((min|max)-)?(consecutive-)?(punctuation|character|
numeral|word|subordinate|sentence|paragraph|chapter|heading|
enumeration|table|cite|format){1}-(added|deleted|changed){1}
<value>=[NUMERAL]
<level>=[STRING]

An exemplary change level declaration according to the present invention may be:

```
minor {
  max-consecutive-characters-added: 10;
  max-words-changed: 2;
  max-punctuations-changed: 20;
}
major {
  min-paragraphs-added: 1;
  min-headings-changed: 2;
}
default {
  use-class: major;
}
```

If no class is met in the example, the default class is applied, which is set to major.

Another exemplary change level declaration according to the present invention may be:

```
spelling-only {
  max-consecutive-characters-changed: 3;
  max-punctuations-changed: 20;
  max-words-added: 0;
}
minor-content-changes {
  max-sentences-changed: 4;
  max-paragraphs-added: 1;
  max-headings-changed: 2;
}
major-content-changes {
  min-chapters-added: 1;
  min-paragraphs-changed: 2;
  min-headings-changed: 3;
}
default {
  use-class: major;
}
```

If no class is met in the example, the default class is applied, which is set to major.

Once the change detection and notification system 50 defines the change-level class of the particular edit, the change-level class is compared on the client side using software programs known in the art such as JavaScript or on the server side on submitting the change or both sides using techniques known in the art such as Ajax.

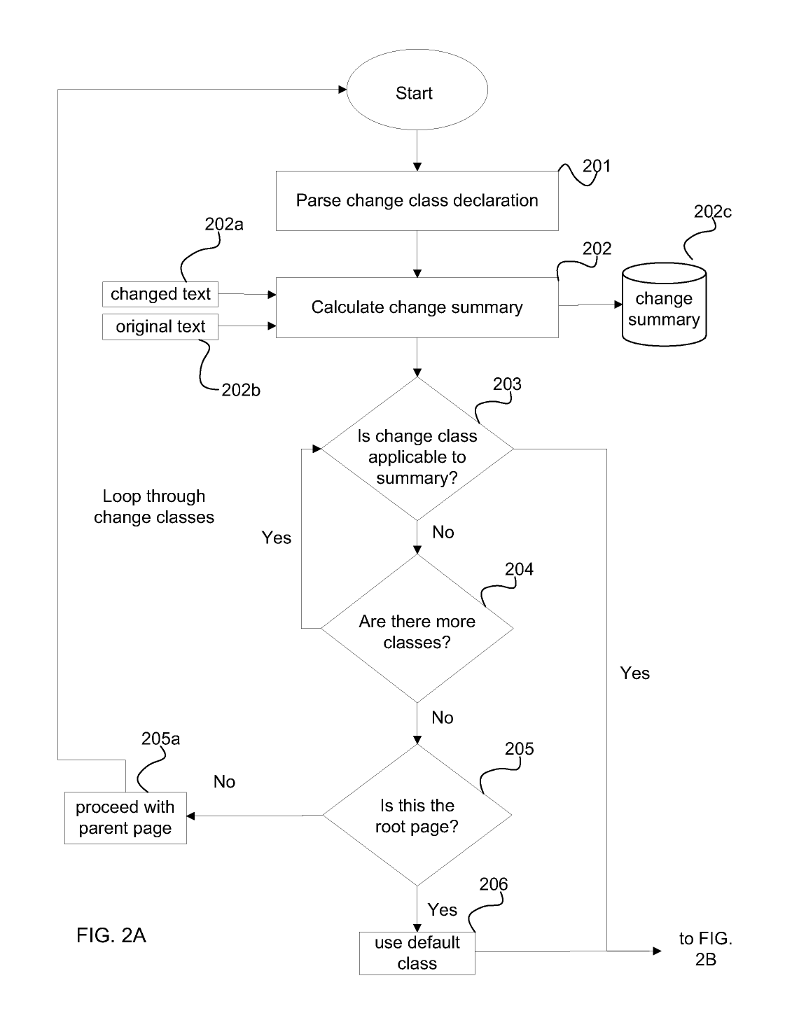

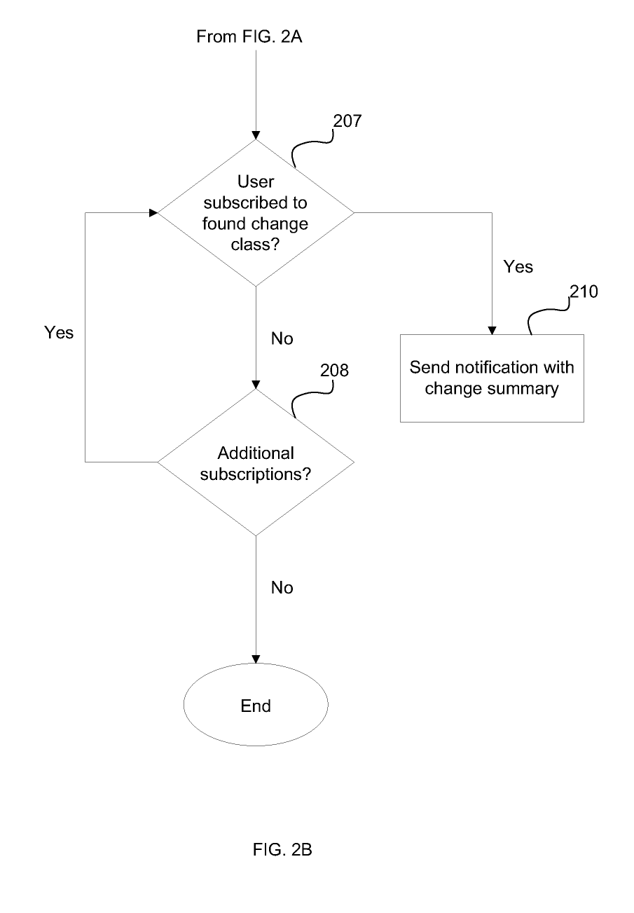

FIGS. 2A and 2B illustrate a procedural flow chart in accordance with one exemplary embodiment of the present invention. At step 201, change detection and notification system 50 parses the change class declared by the author and/or subscribers. At step 202, the change summary is calculated using the inputs of the changed text 202a and the original text 202b. The calculated output is stored in change summary database 202c. At step 203, change class is checked to see whether it is applicable to the output change summary. If the change class is applicable to the summary, change detection and notification system 50 prepares the notification to be sent (see FIG. 2B). If it is not applicable, change detection and notification system 50 continues to step 204 and checks whether there are additional change classes to be checked. If there are additional change classes, change detection and notification system 50 loops through the other change classes by returning to step 203. If there are no other change classes to check, change detection and notification system 50 checks whether the page being checked is the root page at step 205. For example, an Internet website may have many embedded and linked websites. Change detection and notification system 50 may be set to not only checks whether the current website page has been edited, but also whether any parent pages have also been embedded. Therefore, if the present page being checked is not the root page, change detection and notification system 50 proceeds with the parent page at step 205a and loops back to step 201. If change detection and notification system 50 is checking the root page and no change class has been found to be applicable to the change summary, the change class is set to the default class at step 206 and change detection and notification system 50 prepares the notification to be sent.

Once the change detection has been completed and the change class determined, change detection and notification system 50 prepares to send a notification, if needed. First, at step 207, change detection and notification system 50 determines whether a particular user (e.g., author or subscriber) is subscribed to the detected change class. If yes, a notification is sent to the particular user with the change summary from database 202c. If no, change detection and notification system 50 checks to see whether there are additional users that need to be checked (i.e., whether there are multiple subscriptions) at step 208. If there are additional subscriptions, change detection and notification system 50 loops back to step 207 to determine whether the user is subscribed to the found change class. If there are no additional users, change detection and notification system 50 terminates the detection and notification process.

An exemplary pseudo-code implementation in accordance with the present invention is:

```
ChangeClass determineChangeClass(String changedText, String
originalText) {
  //calculate the changes made in the new text
  ChangeSummary summary = calculateChangeSummary(changedText,
  originalText);
  //get the change class which need to be parsed from the change class
  definition before ChangeClass[] classes = getChangeClasses( );
  //iterate over all classes
  for(ChangeClass cc : classes) {
  //if the class is applicable to the calculated changes
  if(cc.isApplicable(summary)) {
    //return the change class that matched the change rate
    return cc;
  }
  }
  //return the default if no matching change class was found
  return getDefaultChangeClass( );
}
sendConditionalNotification(ChangeClass cc, String changedText,
UserSubscription[ ]
users) {
  for(UserSubscription us : users) {
  if(us.getSubscribedChangeClass( ) == cc) {
    sendNotification(us.getEmail( ), changedText);
  }
  }
}
ChangeSummary calculateChangeSummary(String changedText,
originalText) {
  ChangeSummary sum = new ChangeSummary( );
  sum.setChapterChanges( compareChapters(
    getChapters(changedText), getChapters(originalText));
  sum.setParagraphChanges( compareParagraphs(
    getParagraphs(changedText), getParagraphs(originalText));
  ...
  return sum;
}
```

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for automatic change detection and notification comprising the steps of:
storing at least one subscription corresponding to a notification preference of at least one user;
detecting at least one change made to a collaborative editor;
determining the change level class of the at least one change;
comparing the change level class with the notification preference of the at least one user; and
transmitting a notification to the at least one user if the change level class corresponds to the notification preference of the at least one user.
